(19) United States
(12) Patent Application Publication
(10) Pub. No.: US 2020/0132371 A1
(43) Pub. Date: Apr. 30, 2020

(54) A dehumidifying and drying device for straw brick

(71) Applicant: Danyang Mao, Quzhou City (CN)

(72) Inventor: Danyang Mao, Quzhou City (CN)

(21) Appl. No.: 16/732,356

(22) Filed: Jan. 2, 2020

(30) Foreign Application Priority Data
Sep. 19, 2019 (CN) 2019108858437

(51) Int. Cl. F26B 11/02; B29C 35/04; F26B 3/04; F26B 11/04

(52) U.S. Cl. CPC F26B 11/028; B29C 35/045; B29K 2001/00; F26B 11/04; B29C 2035/046; F26B 3/04

(57) ABSTRACT

The invention discloses a straw brick dehumidifying and drying device, which includes a machine body, wherein a molding cavity is provided in the body, a sealing device is provided on the front side of the molding cavity, the sealing device includes a sealing plate, and the rotating device There is a rotating shaft, and a rotating wheel is fixed on the rotating shaft. Seven groups of storage devices are arranged on the outer periphery of the rotating wheel with the rotating shaft as the center. The storage device can place straw bricks. The rotatable rotating wheel drives the straw brick to rotate slowly, and the placement direction of the straw brick is always upward to maintain the stability of its placement. Secondly, the hot air is blown to the molding cavity through the rotation of the fan blades, and the hot air can be converted by the condensation device. It is discharged in a liquid state, and has the function of dehumidifying the molding cavity, thereby keeping the air in the molding cavity dry and improving the efficiency of preparing straw bricks.

### CROSS-REFERENCES TO RELATED APPLICATIONS

The present application claims priority from Chinese application No. 2019108858437 filed on Sep. 19, 2019 which is hereby incorporated by reference in its entirety.

### FIELD OF TECHNOLOGY

The invention relates to the field of straw recycling and using, and in particular relates to a dehumidifying and drying device for straw brick.

### TECHNICAL FIELD

Straw bricks are made from plant straws. After being extruded by a brick making machine, straw bricks are made from renewable resources. Therefore, their environmental protection and ruggedness make straws widely used. However, after the straw bricks are formed, they need to be dried. It is stored and strengthened in the environment, but the existing straw bricks are directly placed on the storage racks after molding. The storage racks are placed in the natural environment. Without dehumidifying and drying the environment, the straw bricks have poor firmness and are easy to crack during use. And, the drying time is long, the preparation process of the straw brick is prolonged, and the efficiency is low. The invention illustrates a device capable of solving the above problems.

### CONTENT OF THE INVENTION

### Technical Problem

Traditional straw bricks have poor firmness, are easy to crack during use, and have a long drying time, prolonging the preparation process of straw bricks, and have low efficiency.

In order to solve the above problems, a straw brick dehumidifying and drying device is designed in this example. The straw brick dehumidifying and drying device in this example includes a machine body, which is provided with a molding cavity, and a sealing device is provided on the front side of the molding cavity The sealing device includes a sealing plate, which can seal the molding cavity to ensure the balance of the air environment in the molding cavity. The molding cavity is provided with a rotation shaft for rotation, and the rotation shaft is fixedly provided. Rotating wheel. Seven groups of storage devices are arranged on the outer periphery of the rotating wheel with the rotating shaft as the center. The storage device can place straw bricks. The right side of the molding cavity is provided with a transmission device. The right end is dynamically connected to the transmission device. A dehumidifying device is provided on the lower side of the molding cavity. The dehumidifying device can blow hot air into the molding cavity. A power conversion device is provided on the lower side of the dehumidifying device. The power conversion device is dynamically connected to the sealing device, so that the operation of the power conversion device can provide power for the dehumidification device and the sealing device, and a condensation device is provided on the upper side of the molding cavity. The condensing means may be a hot air chamber forming the cooling water are formed, thereby forming the outer side of the discharge chamber, said holding cavity forming a dry environment, accelerate the forming of the straw bricks.

Wherein, the sealing device includes an opening and closing cavity, a sealing shaft is rotatably provided in the opening and closing cavity, the sealing plate is fixed on the sealing rotating shaft, and an engaging cavity is provided on the lower side of the opening and closing cavity. The lower end of the sealed rotating shaft extends into the meshing cavity and is fixed with a first bevel gear. The left end of the first bevel gear is meshed with a second bevel gear. A gear rotating shaft is fixed at the center of the second bevel gear. The gear rotating shaft is dynamically connected with the power conversion device, so that the rotation of the sealing plate can be used to open and close the opening and closing cavity, and then control the sealed state of the molding cavity.

Wherein, the storage device includes a left-right symmetrical mounting rod, the mounting rod is fixed on the rotating wheel, a fixing rod is fixed between the mounting rods, and the left-right symmetry is provided on the fixed rod through a bearing rotation. A connecting block, a placing plate is fixed between the connecting blocks, a placing groove is arranged on the placing plate, and the straw brick is placed in the placing groove, so that the rotating wheel can drive the placing plate Rotate, and the placing plate is always located at the lower side of the fixed rod, thereby keeping the straw bricks stable.

Preferably, five of the straw bricks can be placed in a single said trough, so that the straw bricks are evenly placed and the space utilization of the trough is maximized.

Wherein, the transmission device includes a belt cavity, which is in communication with the molding cavity. The belt cavity is provided with an up-and-down symmetrical pulley. The pulleys are power-connected through a transmission belt. The belt pulley on the upper side is fixedly connected, and a belt rotation shaft is fixed at the center of the belt pulley on the lower side. A transmission cavity is connected to the left side of the belt cavity, and the left end of the belt rotation shaft extends into the transmission cavity and is fixed. There is a transmission gear, a meshing gear is meshingly connected to the lower side of the transmission gear, a transmission shaft is fixed at the center of the meshing gear, and the left end of the transmission shaft is dynamically connected with the power conversion device, so that the meshing gear can be driven by rotation The rotation shaft rotates, which in turn drives the storage device to rotate, so that the straw bricks are uniformly dried in the forming cavity.

Preferably, the diameter of the meshing gear is much smaller than the diameter of the transmission gear, and its role is to reduce the speed of the transmission gear when the rotational speed of the meshing gear is transmitted to the transmission gear, thereby making the rotating wheel rotate slowly.

Wherein, the dehumidifying device includes a heating cavity, and the rear side of the heating cavity is in communication with the outside world. Six heating plates are installed in the heating cavity, and a mesh plate is installed on the upper side of the heating plate. The perforated plate allows the hot air generated during the operation of the heating plate to evenly flow into the molding cavity. A mounting block is provided on the lower side of the heating plate, and three fan blades are evenly installed on the outer periphery of the mounting block. A wind shaft is fixed on the end surface, and the lower end of the wind shaft is dynamically connected to the power conversion device, so that the fan blades rotate to generate wind to blow the hot air generated by the heating plate into the molding cavity.

Preferably, the heating plate is electrically connected to external mains electricity, so that after the heating plate is energized, hot air is generated for drying the molding cavity.

The power conversion device includes a moving cavity, and a moving block is slidably arranged in the moving cavity. A power motor is fixed in the moving block. A spline sleeve is installed at the right end of the power motor. The right end of the key sleeve can be splined with the drive shaft. A third bevel gear is fixed on the spline sleeve. A fourth bevel gear is meshed with the upper side of the third bevel gear. The wind shaft is fixedly connected, a spline shaft is installed at the left end of the power motor, a synchronous belt cavity is provided on the left side of the moving cavity, and a hydraulic cylinder is fixed on the left end wall of the synchronous belt cavity, and the right end of the hydraulic cylinder is fixed. A telescopic shaft is mounted on the power, the right end of the telescopic shaft extends into the moving cavity and is fixedly connected to the moving block. The timing belt cavity is provided with front and back symmetrical timing pulleys. The synchronous toothed belt is dynamically connected. A spline groove is provided in the synchronous belt wheel on the rear side. The spline groove can be splined with the spline shaft. The synchronous belt pulley on the front side and the left end of the gear shaft Fixedly connected, so that the spline sleeve is connected to the transmission shaft When, the dehumidifying means and the transmission means is powered, the flower is connected to the key shaft spline grooves, said sealing means providing said power to said working power of the motor power of the motor is working.

Wherein, the condensation device includes a deflector, the right end of the deflector is fixedly installed in the molding cavity, a deflector is provided in the deflector, and the right end wall of the molding cavity communicates with the outside. There is a through hole, a connecting pipe is installed at the right end of the through hole, the connecting pipe is connected to the external drainage system, the connecting pipe, the through hole and the diversion groove communicate with each other, and the upper side of the molding cavity communicates with A cooling chamber, a cooling water pipe is wound around the periphery of the condensation chamber, a water inlet hole is provided on the left side of the condensation chamber, the water inlet hole is in communication with the left end of the cooling water pipe, and a water pump is installed at the left end of the water inlet hole, A water inlet pipe is installed on the left side of the pump, the water inlet pipe is fixedly connected to the left end surface of the body, the water inlet pipe is in communication with the water inlet hole, and a drainage hole is provided on the right side of the condensation chamber, and the drainage The hole communicates with the right end of the cooling water pipe, a drainage pipe is installed on the right side of the drainage hole, the drainage pipe is fixedly connected to the right end face of the body, and the drainage pipe is in communication with the drainage hole, so that the pump works Circulating cold water through the cooling water pipe, Discharged through the hot air flow guiding groove intracavitary condensed to a liquid.

The beneficial effect of the present invention is that the straw brick is slowly rotated by the rotatable rotating wheel, and the placement direction of the straw brick is always upward to maintain the stability of its placement. Secondly, the hot air is blown to the molding cavity by the fan blade rotation. It can accelerate the drying of straw bricks after forming, and can convert hot air into a liquid state through a condensing device to dehumidify the forming cavity, thereby keeping the air in the forming cavity dry and improving the efficiency of preparing straw bricks.

### BRIEF DESCRIPTION OF THE DRAWINGS

For ease of description, the present invention is described in detail by the following specific embodiments and the accompanying drawings.

FIG. 1 is a schematic diagram of the overall structure of a straw brick dehumidifying and drying device according to the present invention;

FIG. 2 is a schematic structural view in the direction of “A-A” of FIG. 1;

FIG. 3 is an enlarged structural diagram of “B” of FIG. 2;

FIG. 4 is an enlarged structural diagram of “C” in FIG. 1;

FIG. 5 is a schematic diagram of the structure in the “D-D” direction of FIG. 2.

### DETAILED DESCRIPTION OF THE INVENTION

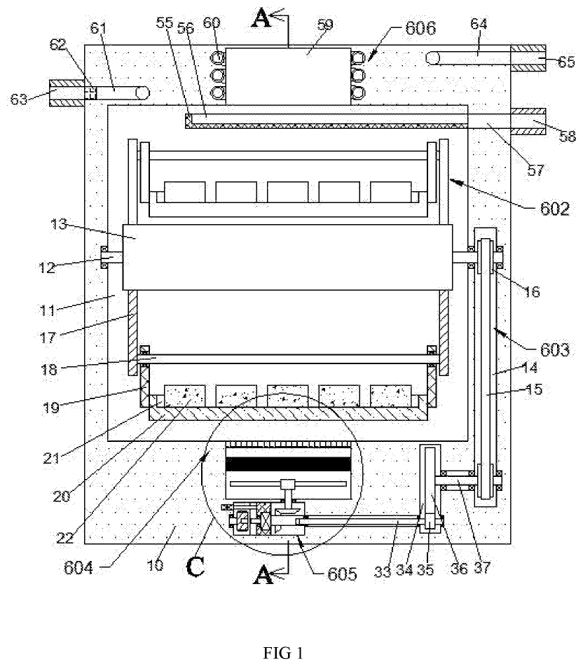

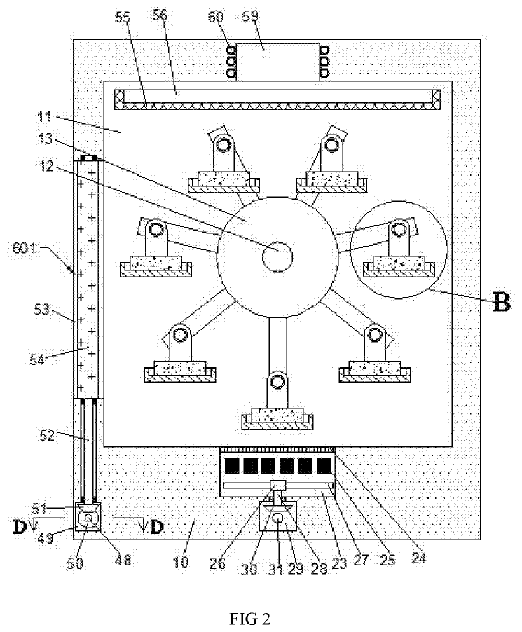

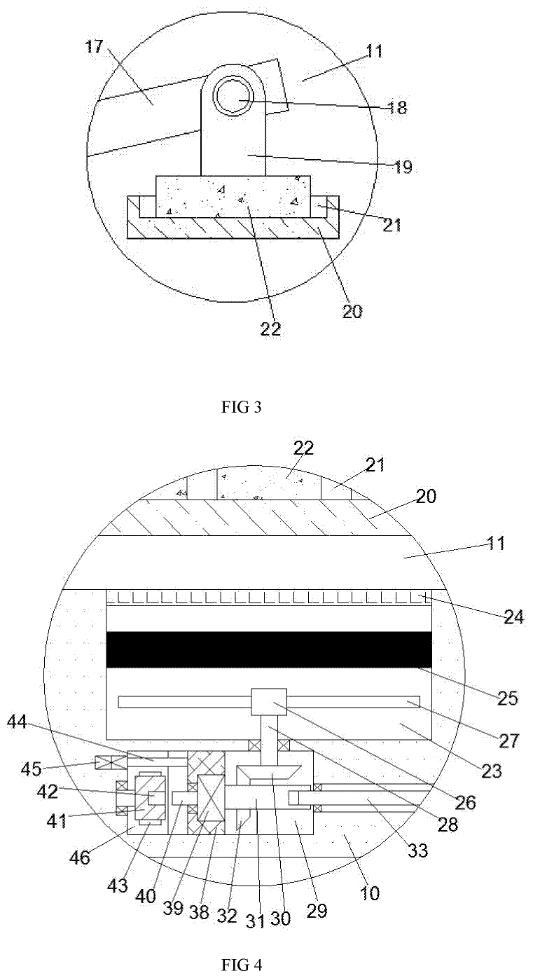

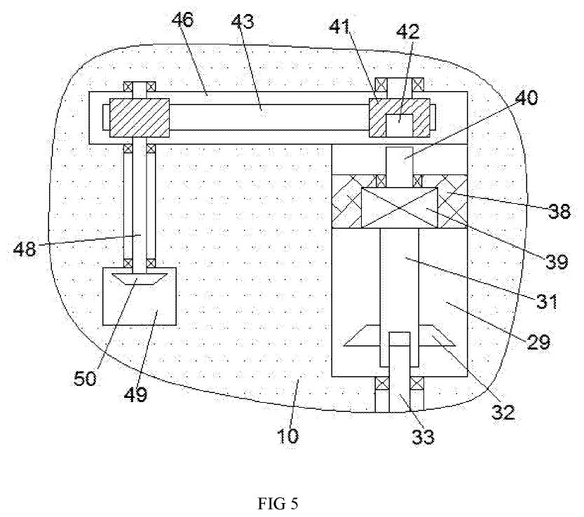

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1 itself.

The invention relates to a straw brick dehumidifying and drying device, which is mainly used for forming and storing straw bricks. The invention will be further described below with reference to the accompanying drawings of the invention:

The straw brick dehumidifying and drying device according to the present invention comprises a machine body 10 which is provided with a molding cavity 11 therein. A sealing device 601 is provided on the front side of the molding cavity 11, and the sealing device 601 includes a sealing plate 54. The sealing plate 54 can seal the molding cavity 11 to ensure the balance of the air environment in the molding cavity 11. A rotating shaft 12 is rotatably provided in the molding cavity 11, and a rotating wheel is fixed on the rotating shaft 12. 13. Seven groups of storage devices 602 are arranged on the outer periphery of the rotating wheel 13 around the rotating shaft 12 as a center. The storage device 602 can be placed with straw bricks 22, and a transmission device is provided on the right side of the molding cavity 11. 603, the right end of the rotating shaft 12 is dynamically connected with the transmission device 603, and a dehumidifying device 604 is provided on the lower side of the molding cavity 11, and the dehumidifying device 604 can blow hot air into the molding cavity 11, A power conversion device 605 is provided on the lower side of the dehumidification device 604, and the power conversion device 605 is power-connected to the sealing device 601. Then, the work of the power conversion device 605 can provide work for the dehumidification device 604 and the sealing device 601. Power on the forming cavity 11 A condensing device 606 is provided on the side, and the condensing device 606 can cool the hot air of the molding cavity 11 to form water, thereby exhausting the outside of the molding cavity 11 to maintain a dry environment in the molding cavity 11 and speed up the straw. Forming of the brick 22.

According to the embodiment, the sealing device 601 is described in detail below. The sealing device 601 includes an opening and closing cavity 53. A sealing shaft 52 is rotatably provided in the opening and closing cavity 53, and the sealing plate 54 is fixed on the sealing shaft. On 52, a lower side of the opening and closing chamber 53 is provided with a meshing cavity 49, and a lower end of the seal rotating shaft 52 extends into the meshing cavity 49 and a first bevel gear 51 is fixedly located at the left end of the first bevel gear 51 A second bevel gear 50 is meshed and connected, and a gear rotating shaft 48 is fixed at the center of the second bevel gear 50. The gear rotating shaft 48 is dynamically connected with the power conversion device 605, so that the seal plate 54 can be used to open The opening and closing cavity 53 is closed to further control the sealed state of the molding cavity 11.

According to the embodiment, the storage device 602 is described in detail below. The storage device 602 includes a left-right symmetrical mounting rod 17 fixed on the rotating wheel 13 and fixed between the mounting rods 17. There are fixing rods 18, and the left and right symmetrical connecting blocks 19 are provided on the fixing rods 18 through rotation of the bearings. Between the connecting blocks 19, a placing plate 20 is fixed, and the placing plate 20 is provided with a placing groove 21. The straw brick 22 is placed in the placement groove 21, so that the rotation of the rotating wheel 13 can drive the placement plate 20 to rotate, and the placement plate 20 is always located at the lower side of the fixing rod 18, thereby keeping the smoothness of the straw brick 22.

Beneficially, five of the straw bricks 22 can be placed in a single of the placing grooves 21, so that the straw bricks 22 are evenly placed and the space utilization of the placing grooves 21 is maximized.

According to the embodiment, the transmission device 603 is described in detail below. The transmission device 603 includes a belt cavity 14 which communicates with the molding cavity 11. The belt cavity 14 is provided with a vertically symmetrical pulley 16. The pulleys 16 are dynamically connected by a transmission belt 15. The right end of the rotating shaft 12 is fixedly connected with the pulley 16 on the upper side. A belt rotating shaft 37 is fixed at the center of the pulley 16 on the lower side. 14 is connected with a transmission cavity 34 on the left side, and the left end of the belt rotating shaft 37 extends into the transmission cavity 34 and a transmission gear 36 is fixed thereon. The transmission gear 36 is meshed with a meshing gear 35 on the lower side. A transmission shaft 33 is fixed at the center of 35, and the left end of the transmission shaft 33 is dynamically connected to the power conversion device 605, so that the rotation of the meshing gear 35 can drive the rotation shaft 12 to rotate, and then the storage device 602 to rotate So that the straw bricks 22 are uniformly dried in the forming cavity 11.

Beneficially, the diameter of the meshing gear 35 is much smaller than the diameter of the transmission gear 36, and its function is that when the rotational speed of the meshing gear 35 is transmitted to the transmission gear 36, the transmission gear 36 is decelerated, which in turn makes The rotating wheel 13 rotates slowly.

According to the embodiment, the dehumidification device 604 will be described in detail below. The dehumidification device 604 includes a heating cavity 23 that communicates with the outside of the heating cavity 23. Six heating plates 25 are installed in the heating cavity 23. A mesh plate 24 is installed on the upper side of the heating plate 25, and the mesh plate 24 can make the hot gas generated during the operation of the heating plate 25 evenly flow into the molding cavity 11, and the lower side of the heating plate 25 A mounting block 26 is provided, and three fan blades 27 are uniformly mounted on the outer periphery of the mounting block 26. A wind shaft 28 is fixed on a lower end surface of the mounting block 26, and a lower end of the wind shaft 28 is dynamically connected to the power conversion device 605. Therefore, the fan blade 27 rotates to generate wind to blow the hot air generated by the heating plate 25 into the molding cavity 11.

Beneficially, the heating plate 25 is electrically connected to the external mains electricity, so that after the heating plate 25 is powered on, hot air is generated for drying the molding cavity 11.

According to the embodiment, the power conversion device 605 will be described in detail below. The power conversion device 605 includes a moving cavity 29, and a moving block 38 is slidably provided in the moving cavity 29, and power is fixed in the moving block 38. A motor 39 is splined at the right end of the power motor 39. A splined sleeve 31 is splined to the right end of the splined sleeve 31, and a third bevel gear 32 is fixed on the splined sleeve 31. A fourth bevel gear 30 is meshingly connected to the upper side of the third bevel gear 32. The fourth bevel gear 30 is fixedly connected to the wind shaft 28. A spline shaft 40 is installed at the left end of the power motor 39. The left side of the moving cavity 29 is provided with a synchronous belt cavity 46. The left end wall of the synchronous belt cavity 46 is fixed with a hydraulic cylinder 45. The right end of the hydraulic cylinder 45 is powered by a telescopic shaft 44. The right end of the telescopic shaft 44 extends to The moving cavity 29 is fixedly connected to the moving block 38. The synchronous belt cavity 46 is provided with a front-rear synchronous belt pulley 41. The synchronous belt pulleys 41 are dynamically connected through a synchronous toothed belt 43, A spline groove 42 is provided in the timing belt pulley 41 on the rear side, and the spline groove 42 and the flower The shaft 40 can be splined, and the synchronous pulley 41 on the front side is fixedly connected to the left end of the gear rotating shaft 48, so that when the splined sleeve 31 is connected to the transmission shaft 33, the power motor 39 works as The dehumidifying device 604 and the transmission device 603 provide power, and when the spline shaft 40 is connected to the spline groove 42, the power motor 39 works to provide power to the sealing device 601.

According to the embodiment, the condensing device 606 will be described in detail below. The condensing device 606 includes a deflector 55, and the right end of the deflector 55 is fixedly installed in the molding cavity 11. Diversion groove 56, a through hole 57 is provided between the right end wall of the molding cavity 11 and the outside, and a connecting pipe 58 is installed at the right end of the through hole 57. The connecting pipe 58 is connected to the external drainage system, and the connecting pipe 58. The through hole 57 and the guide groove 56 communicate with each other. A condensing cavity 59 is communicated on the upper side of the molding cavity 11. A cooling water pipe 60 is wound around the periphery of the condensing cavity 59. The left side of the condensing cavity 59 is A water inlet 61 is provided, and the water inlet 61 is in communication with the left end of the cooling water pipe 60. A water pump 62 is installed at the left end of the water inlet 61, and a water inlet 63 is installed at the left side of the water pump 62. A water inlet pipe 63 is fixedly connected to the left end surface of the body 10, the water inlet pipe 63 is in communication with the water inlet hole 61, a drainage hole 64 is provided on the right side of the condensation chamber 59, and the drainage hole 64 is connected to the cooling water pipe 60 is connected to the right end, and a drainage pipe 65 is installed on the right side of the drainage hole 64, and the drainage pipe 65 is on the right end face of the body 10. Furthermore, the drain pipe 65 communicates with the drain hole 64, so that the suction pump 62 works to circulate cold water through the cooling water pipe 60, condense the hot gas in the condensation chamber 59 into a liquid state, and pass through the diversion. The groove 56 is discharged.

The following describes in detail the use steps of a straw brick dehumidifying and drying device in conjunction with FIG. 1 to FIG. 5:

Initially, the spline shaft 40 is splined to the rear synchronous pulley 41, the spline sleeve 31 is not connected to the transmission shaft 33, and the third bevel gear 32 and the fourth bevel gear 30 are not meshed. The water inlet pipe 63 is connected to the outside. The water system is connected, and the drainage pipe 65 is connected to an external drainage system.

When in use, the power motor 39 works and drives the spline shaft 40 to rotate, the synchronous pulley 41 rotates, and the second bevel gear 50 rotates through the synchronous toothed belt 43, the first bevel gear 51 rotates, and the seal plate 54 rotates. The opening and closing cavity 53 is opened, and after that, the straw bricks 22 are evenly placed on the placing plate 20, and then, the power motor 39 rotates in the reverse direction to make the synchronous toothed belt 43 reverse, and the second bevel gear 50 drives the first cone. The gear 51 is reversed, so that the sealing plate 54 is rotated in the reverse direction to seal the opening and closing cavity 53;

When the power is changed, the hydraulic cylinder 45 works and drives the telescopic shaft 44 to extend. Then, the moving block 38 moves to the right to disengage the spline shaft 40 from the synchronous pulley 41. The spline sleeve 31 is splined to the transmission shaft 33 and the third cone The gear 32 meshes with the fourth bevel gear 30;

When the air in the molding cavity 11 is dehumidified and dried, the heating plate 25 is energized to heat the air, and the power motor 39 works to drive the spline sleeve 31 to rotate. Then, the third bevel gear 32 drives the fourth bevel gear 30 to rotate, so that the fan blade 27 is rotated. The wind blows hot air into the molding cavity 11 to dry the straw bricks 22. When the spline sleeve 31 rotates, the transmission shaft 33 rotates, and the meshing gear 35 drives the transmission gear 36 to rotate. The transmission wheel 15 causes the rotation wheel 13 to rotate. Furthermore, the straw bricks 22 in the seven placing plates 20 rotate uniformly and slowly around the rotating wheel 13 and the straw bricks 22 are always located at the lower side of the fixed rod 18 to maintain balance. The hot air in the molding cavity 11 flows upward into the condensation cavity 59 When it is inside, the suction pump 62 works, and draws cold water from the outside into the cooling water pipe 60. The circulation of the cooling water pipe 60 causes the hot air in the condensation chamber 59 to condense to form a liquid, flows into the guide groove 56, and is discharged through the connection pipe 58. The molding cavity 11 is dehumidified and dried, and the drying of the straw brick 22 is accelerated.

The beneficial effect of the present invention is that the straw brick is slowly rotated by the rotatable rotating wheel, and the placement direction of the straw brick is always upward to maintain the stability of its placement. Secondly, the hot air is blown to the molding cavity by the fan blade rotation. It can accelerate the drying of straw bricks after forming, and can convert hot air into a liquid state through a condensing device to dehumidify the forming cavity, thereby keeping the air in the forming cavity dry and improving the efficiency of preparing straw bricks.

In the above manner, those skilled in the art can make various changes according to the working mode within the scope of the present invention.

1. A straw brick dehumidifying and drying device, including a body; a molding cavity is provided in the body, and a sealing device is provided on the front side of the molding cavity. The sealing device includes a sealing plate, which can seal the molding cavity to ensure the balance of the air environment in the molding cavity. A rotation shaft is provided for rotation in the molding cavity, and a rotation wheel is fixed on the rotation shaft. Seven groups of storage devices are arranged on the outer periphery of the rotation wheel with the rotation axis as the center. Place straw bricks; a transmission device is provided on the right side of the molding cavity, and the right end of the rotating shaft is dynamically connected to the transmission device. A dehumidification device is provided on the lower side of the molding cavity, and the dehumidification device can blow hot air into the molding cavity. A power conversion device is provided on the lower side of the dehumidification device, and the power conversion device is dynamically connected with the sealing device, the work of the power conversion device can provide power for the work of the dehumidification device and the sealing device; a condensing device is provided on the upper side of the molding cavity, and the condensing device can cool the hot air in the molding cavity to form water, thereby discharging the outside of the molding cavity, maintaining a dry environment in the molding cavity, and accelerating the straw. Molding of bricks.

2. The dehumidifying and drying device for straw bricks according to claim 1, wherein the sealing device comprises an opening and closing cavity; a sealing shaft is rotatably provided in the opening and closing cavity, and the sealing plate is fixed on the sealing shaft; a meshing cavity is provided on the lower side of the opening and closing cavity. The lower end of the sealed rotating shaft extends into the meshing cavity and a first bevel gear is fixed. A left side of the first bevel gear is meshed with a second bevel gear. A gear rotating shaft is fixed at the center of the second bevel gear, and the gear rotating shaft is dynamically connected with the power conversion device.

3. The dehumidifying and drying device for straw bricks according to claim 1, wherein the storage device comprises left-right symmetrical mounting rods; the mounting rod is fixed on the rotating wheel, and fixed rods are fixed between the mounting rods, and the left and right symmetrical connection blocks are provided on the fixed rod through rotation of bearings; a placing plate is fixed between the connecting blocks, a placing groove is arranged on the placing plate, and the straw brick is placed in the placing groove.

4. The straw brick dehumidifying and drying device according to claim 3, characterized in that five said straw bricks can be placed in a single said placing tank.

5. The dehumidifying and drying device for straw bricks according to claim 1, wherein the transmission device comprises a belt cavity; the belt cavity is in communication with the molding cavity. The belt cavity is provided with symmetrical upper and lower pulleys. The pulleys are dynamically connected by a transmission belt. The right end of the rotating shaft is fixedly connected to the upper pulley. A belt rotation shaft is fixed at the center of the pulley on the side; the left side of the belt cavity is provided with a transmission cavity. The left end of the belt rotation shaft extends into the transmission cavity and a transmission gear is fixed. The transmission gear is meshed with a meshing gear on the lower side. A transmission shaft is provided, and the left end of the transmission shaft is dynamically connected with the power conversion device.

6. The straw brick dehumidifying and drying device according to claim 5, wherein the diameter of the meshing gear is much smaller than the diameter of the transmission gear.

7. The dehumidifying and drying device for straw bricks according to claim 1, wherein the dehumidifying device comprises a heating cavity; the rear side of the heating cavity is in communication with the outside world. Six heating plates are installed in the heating cavity, and a mesh plate is installed on the upper side of the heating plate. The mesh plate can make the heating plate work when it is working. The hot gas evenly flows into the forming cavity; a mounting block is arranged on the lower side of the heating plate, and three fan blades are evenly installed on the outer periphery of the mounting block. A wind shaft is fixed on the lower end surface of the mounting block, and the lower end of the wind shaft is dynamically connected to the power conversion device.

8. The dehumidifying and drying device for straw bricks according to claim 7, characterized in that the heating plate is electrically connected to external mains electricity.

9. The straw brick dehumidifying and drying device according to claim 1, wherein the power conversion device comprises a moving cavity; a moving block is slidably arranged in the moving cavity, and a power motor is fixed in the moving block. A spline sleeve is installed at the right end of the power motor, and the spline sleeve has a right end that can be splined with the transmission shaft. A third bevel gear is fixed on the spline sleeve, a fourth bevel gear is meshed and connected on the upper side of the third bevel gear, the fourth bevel gear is fixedly connected to the wind shaft, and the power motor A spline shaft is installed at the left end of the power; the left side of the moving cavity is provided with a synchronous belt cavity. A hydraulic cylinder is fixed on the left end wall of the synchronous belt cavity. A power telescopic shaft is installed at the right end of the hydraulic cylinder, and the right end of the telescopic shaft extends into the moving cavity. It is fixedly connected to the moving block. The front and rear symmetrical belt pulleys are provided in the belt cavity. The belt pulleys are connected by a synchronous toothed belt. The rear belt is provided with flowers. A key slot, wherein the spline slot and the spline shaft can be splined, and the timing belt wheel on the front side is fixedly connected with the left end of the gear rotating shaft.

10. The dehumidifying and drying device for straw bricks according to claim 1, wherein the condensation device comprises a deflector; the right end of the deflector is fixedly installed in the molding cavity. A deflector is provided in the deflector. A through hole is provided between the right end wall of the molding cavity and the outside, and a right end of the through hole is installed. A connecting pipe, which is connected to the external drainage system, the connecting pipe, the through hole and the diversion groove communicate with each other, a condensing cavity is provided on the upper side of the molding cavity, and the condensing cavity is wound around the periphery Cooling water pipe; a water inlet hole is provided on the left side of the condensation chamber, and the water inlet hole is in communication with the left end of the cooling water pipe. A pump is installed on the left end of the water inlet hole, and a water inlet pipe is installed on the left side of the water pump. A water pipe is fixedly connected to the left end face of the body, the water inlet pipe is in communication with the water inlet hole, a drainage hole is provided on the right side of the condensation cavity, the drainage hole is communicated with the right end of the cooling water pipe, and the drainage hole is right A drainage pipe is installed on the side, the drainage pipe is fixedly connected to the right end face of the body, and the drainage pipe is in communication with the drainage hole.
